(19) United States
(12) Patent Application Publication
(10) Pub. No.: US 2013/0014053 A1
(43) Pub. Date: Jan. 10, 2013

(54) Menu Gestures

(75) Inventors: Luis E. Cabrera-Cordon, Bothell, WA (US); Jonathan D. Garn, North Bend, WA (US); Yee Shian Lee, San Diego, CA (US); Ching Man Esther Gall, Bellevue, WA (US); Erik L. De Bonte, Woodinville, WA (US)

(73) Assignee: Microsoft Corporation, Redmond, WA (US)

(21) Appl. No.: 13/178,193

(22) Filed: Jul. 7, 2011

(51) Int. Cl. G06F 3/048

(52) U.S. Cl. 715/810

(57) ABSTRACT

Menu gesture techniques are described. In one or more implementations, a menu is displayed on a display device of a computing device. The menu has a plurality of selectable items along with a visual indication that is configured to follow a touch input across the display device and indicate that each of the plurality of selectable items is selectable via a drag gesture. One or more inputs are recognized by the computing device as movement of the touch input across the display device to identify the drag gesture to select at least one of the plurality of selectable items in the menu.

### BACKGROUND

The amount of functionality that is available from computing devices is ever increasing, such as from mobile devices, game consoles, televisions, set-top boxes, personal computers, and so on. However, traditional techniques that were employed to interact with the computing devices may become less efficient as the amount of functionality increases.

Further, the ways in which user's may access this functionality may differ between devices and device configurations. Consequently, complications may arise when a user attempts to utilize an unfamiliar device or device configuration, which may include a user having difficulty in determining how to interact with the devices.

### SUMMARY

Menu gesture techniques are described. In one or more implementations, a menu is displayed on a display device of a computing device. The menu has a plurality of selectable items along with a visual indication that is configured to follow a touch input across the display device and indicate that each of the plurality of selectable items is selectable via a drag gesture. One or more inputs are recognized by the computing device as movement of the touch input across the display device to identify the drag gesture to select at least one of the plurality of selectable items in the menu.

In one or more implementations, an apparatus includes a display device and one or more modules implemented at least partially in hardware. The one or more modules are configured to generate a menu for display on the display device, the menu having a plurality of items that are selectable using both drag and tap gestures.

In one or more implementations, one or more computer-readable storage media comprise instructions stored thereon that, responsive to execution by a computing device, cause the computing device to generate a menu for display on a display device of the computing device along with a visual indication that is configured to follow a touch input across the display device and indicate that each of a plurality of items of the menu is selectable via a drag gesture, the plurality of items also selectable via a tap gesture.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ gesture techniques.

FIG. 2 depicts an example implementation of output of a hierarchical level of a menu in response to selection of a menu header icon in FIG. 1.

FIG. 3 depicts an example implementation in which a visual indication of availability of a drag gesture follows movement of a touch input across a display device.

FIG. 4 depicts an example implementation in which a result of selection of an item in a previous hierarchical level in a menu is shown as causing output of another hierarchical level in the menu.

FIG. 5 depicts an example implementation showing that availability of exiting from menu selection without selecting an item may be indicated by removing the visual indication from display when outside of a boundary.

FIG. 6 is a flow diagram depicting a procedure in an example implementation in which a menu is configured to indicate support for drag gestures using a visual indication.

FIG. 7 is a flow diagram depicting a procedure in an example implementation in which a menu is generated for display and configured accordingly to detected interaction with the menu.

FIG. 8 illustrates an example system that includes the computing device as described with reference to FIGS. 1-5.

FIG. 9 illustrates various components of an example device that can be implemented as any type of portable and/or computer device as described with reference to FIGS. 1-5 to implement embodiments of the gesture techniques described herein.

### DETAILED DESCRIPTION

Overview

Users may have access to a wide variety of devices in a wide variety of configurations. Because of these different configurations, the devices may employ different techniques to support user interaction. However, these different techniques may be unfamiliar to a user when first interacting with the device, which may lead to user frustration and even cause the user to forgo use of the device altogether.

Menu gesture techniques are described. In one or more implementations, the techniques are configured to take into consideration a skill set and expectation of an end user. For example, the techniques may be configured to address different types of users that have different backgrounds when interacting with a computing device. Users that have a background using cursor control based interfaces, for instance, may be more prone to using “taps” to select items in a user interface using touchscreen functionality. However, users that have a background in touch-enabled devices may be aware of other functionality that may be enabled through use of the touchscreen device, such as drag gestures. Accordingly, in one or more implementations techniques are configured to react to both types of users, which may also help users discover the techniques that are available to interact with a user interface. These techniques may include use of a visual indication to suggest availability of a drag gesture to users that are familiar with tap gestures, use of techniques to support both tap and drag gestures, use of a design to reduce a likelihood that items in a menu are obscured by a user's interaction with the computing device, and so on. Further discussion of these and other techniques may be found in relation to the following sections.

In the following discussion, an example environment is first described that is operable to employ the menu gesture techniques described herein. Example illustrations of gestures and procedures involving the gestures are then described, which may be employed in the example environment as well as in other environments. Accordingly, the example environment is not limited to performing the example gestures and procedures. Likewise, the example procedures and gestures are not limited to implementation in the example environment.

### Example Environment

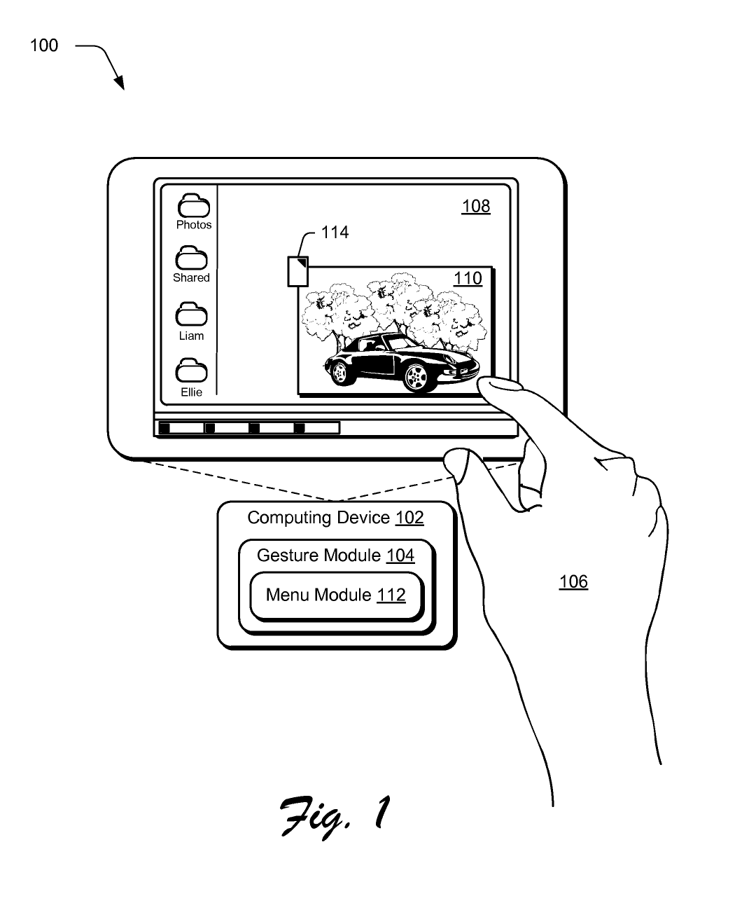

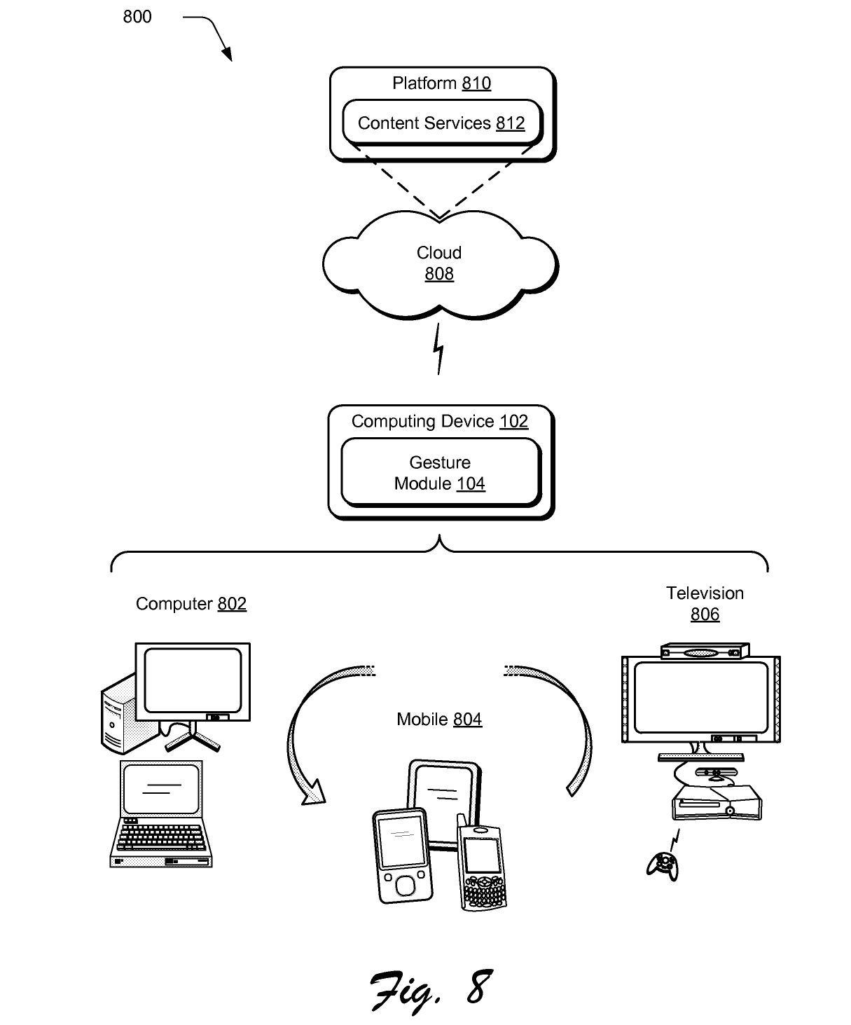

FIG. 1 is an illustration of an environment 100 in an example implementation that is operable to employ menu gesture techniques. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, and so forth as further described in relation to FIG. 8. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 may also relate to software that causes the computing device 102 to perform one or more operations.

The computing device 102 is illustrated as including a gesture module 104. The gesture module 104 is representative of functionality to identify gestures and cause operations to be performed that correspond to the gestures. The gestures may be identified by the gesture module 104 in a variety of different ways. For example, the gesture module 104 may be configured to recognize a touch input, such as a finger of a user's hand 106 as proximal to a display device 108 of the computing device 102 using touchscreen functionality.

The touch input may also be recognized as including attributes (e.g., movement, selection point, etc.) that are usable to differentiate the touch input from other touch inputs recognized by the gesture module 104. This differentiation may then serve as a basis to identify a gesture from the touch inputs and consequently an operation that is to be performed based on identification of the gesture.

For example, a finger of the user's hand 106 is illustrated as selecting an image 110 displayed by the display device 108. Selection of the image 110 and subsequent movement of the finger of the user's hand 106 across the display device 108 may be recognized by the gesture module 104. The gesture module 104 may then identify this recognized movement as a movement gesture to initiate an operation to change a location of the image 110 to a point in the display device 108 at which the finger of the user's hand 106 was lifted away from the display device 108. Therefore, recognition of the touch input that describes selection of the image, movement of the selection point to another location, and then lifting of the finger of the user's hand 106 from the display device 108 may be used to identify a gesture (e.g., movement gesture) that is to initiate the movement operation.

In this way, a variety of different types of gestures may be recognized by the gesture module 104. This includes gestures that are recognized from a single type of input (e.g., touch gestures such as the previously described drag-and-drop gesture) as well as gestures involving multiple types of inputs. Additionally, the gesture module 104 may be configured to differentiate between inputs and therefore the number of gestures that are made possible by each of these inputs alone is also increased. For example, although the inputs may be similar, different gestures (or different parameters to analogous commands) may be indicated using touch inputs versus stylus inputs. Likewise, different inputs may be utilized to initiate the same gesture, such as selection of an item as further described below.

Additionally, although the following discussion may describe specific examples of inputs, in instances the types of inputs may be defined in a variety of ways to support the same or different gestures without departing from the spirit and scope thereof. Further, although in instances in the following discussion the gestures are illustrated as being input using touchscreen functionality, the gestures may be input using a variety of different techniques by a variety of different devices such as depth-sensing cameras, further discussion of which may be found in relation to the FIG. 8.

The gesture module 104 is further illustrated as including a menu module 112. The menu module 112 is representative of functionality of the computing device 102 relating to menus. For example, the menu module 112 may employ techniques to support different types of users. A first type of user may be familiar with user interfaces that utilize cursor control devices. This type of user tends to “tap” to make selections in the user interface, such as by “tapping” the finger of the user's hand over a display of the image 110 to select the image 110. A second type of user may be familiar with dragging gestures due to familiarity with touchscreen devices such as mobile phones and tablet computers as illustrated.

To support these different types of users, the menu module 112 may utilize techniques that support both types of user interactions. Additionally, these techniques may be configured to enable users to learn about the availability of the different techniques that are supported by the menu module 112. For example, the menu module 112 may support a visual indication that drag gesture functionality is available to select items in a menu.

For example, a finger of the user's hand 106 may be used to select a menu header icon 114, which is illustrated at a top-left corner of the image 110. The menu module 112 may be configured to display the menu header icon 114 responsive to detecting interaction of a user with a corresponding item, e.g., the image 110 in this example. For instance, the menu module 112 may detect proximity of the finger of the user's hand 106 to the display of the image 110 to display the menu header icon 114. Other instances are also contemplated, such as to continually display the menu header icon 114 with the image. The menu header icon 114 includes an indication displayed as a triangle in an upper-right corner of the icon to indicate that additional items in a menu are available for display upon selection of the icon, although other representations are also contemplated to indicate availability do additional hierarchical levels in the menu.

The menu header icon 114 may be selected in a variety of ways. For instance, a user may “tap” the icon similar to a “mouse click.” In another instance, a finger of the user's hand 106 may be held “over” the icon to cause output of the items in the menu. An example of output of the menu may be found in relation to the following figure.

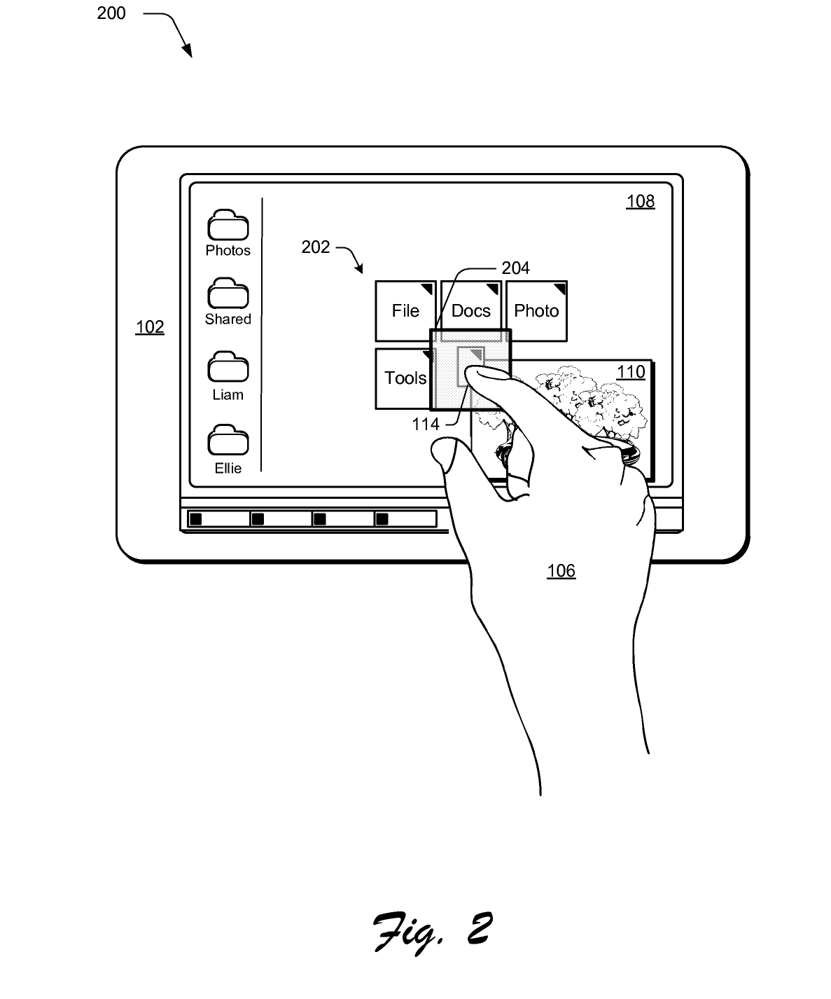

FIG. 2 depicts an example implementation 200 of output of a hierarchical level 202 of a menu in response to selection of the menu header icon 114 in FIG. 1. In the illustrated example, a finger of the user's hand 106 is illustrated as selecting the menu header icon 114. In response, the menu module 112 may cause output of a hierarchical level 202 of a menu that includes a plurality of items that are selectable. Illustrated examples of selectable items include “File,” “Docs,” “Photo,” and “Tools.” Each of these items is further illustrated as including an indication that an additional level in the hierarchical menu is available through selection of the item, which is illustrated as a triangle in the upper-right corner of the items as before.

The items are also positioned for display by the menu module 112 such that the items are not obscured by the user's hand 106. For example, the items may be arranged radially from a point of contact of the user, e.g., the finger of the user's hand 106 in this example. Thus, a likelihood is reduced that any one of the items in the hierarchical level 202 of the menu being displayed is obscured for viewing by a user by the user's hand 106.

A visual indication 204 is also illustrated as being displayed as surrounding a contact point of the finger of the user's hand 106. The visual indication is configured to indicate that a selection may be made by dragging of a touch input (e.g., the finger of the user's hand 106) across the display device 108. Thus, the menu module 112 may provide an indication that drag gestures are available, which may help users such as traditional cursor control device users that are not familiar with drag gestures to discover availability of the drag gestures.

The visual indication 204 may be configured to follow movement of the touch input across the surface of the display device 108. For example, the visual indication 204 is illustrated as surrounding an initial selection point (e.g., the menu header icon 114) in FIG. 2. The visual indication in this example is illustrated as including a border and being translucent to view an “underlying” portion of the user interface. In this way, the user may move the touch input (e.g., the finger of the user's hand 106) across the display device 108 and have the visual indication 204 follow this movement to select an item, an example of which is shown in the following figures.

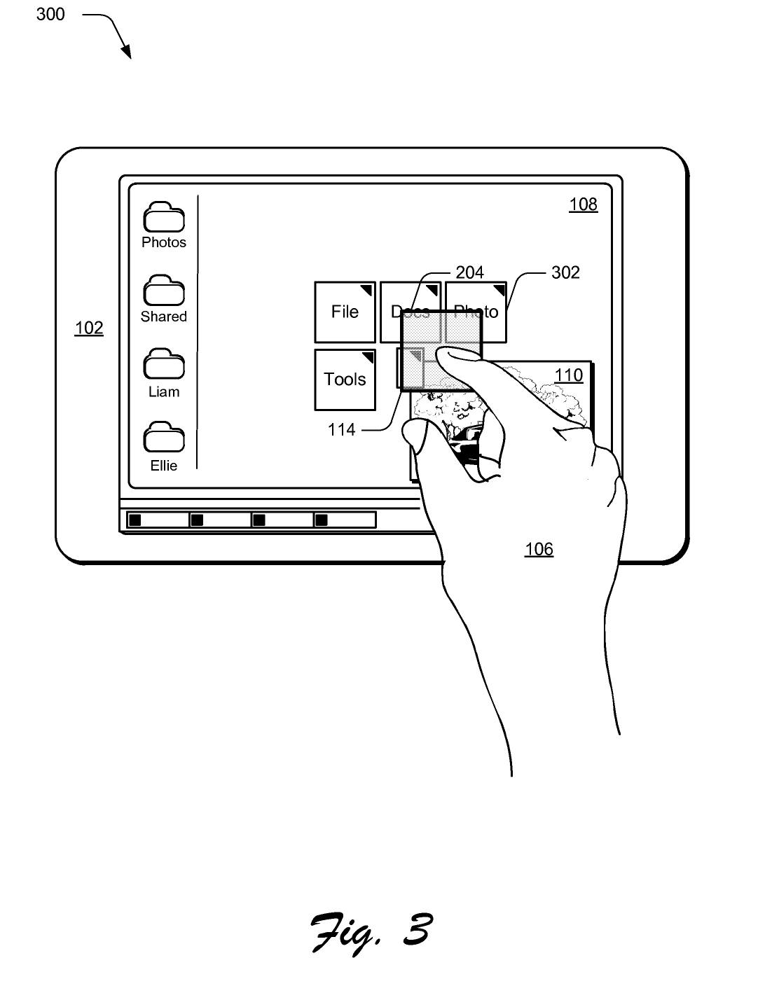

FIG. 3 depicts an example implementation 300 in which the visual indication 204 of availability of a drag gesture follows movement of a touch input across a display device 108. In the illustrated example, the visual indication 204 is illustrated as following movement of a touch input from the menu header icon 114 to an item in the hierarchical level 202 of the menu, which in this instance is a photo 302 item.

Thus, the visual indication 204 may serve to encourage a user to maintain contact with the display device 108 to perform the drag gesture, as opposed to removal of the touch input (e.g., lifting of the finger of the user's hand from the display device 108) as would be performed using a tap gesture to make a selection through successive taps.

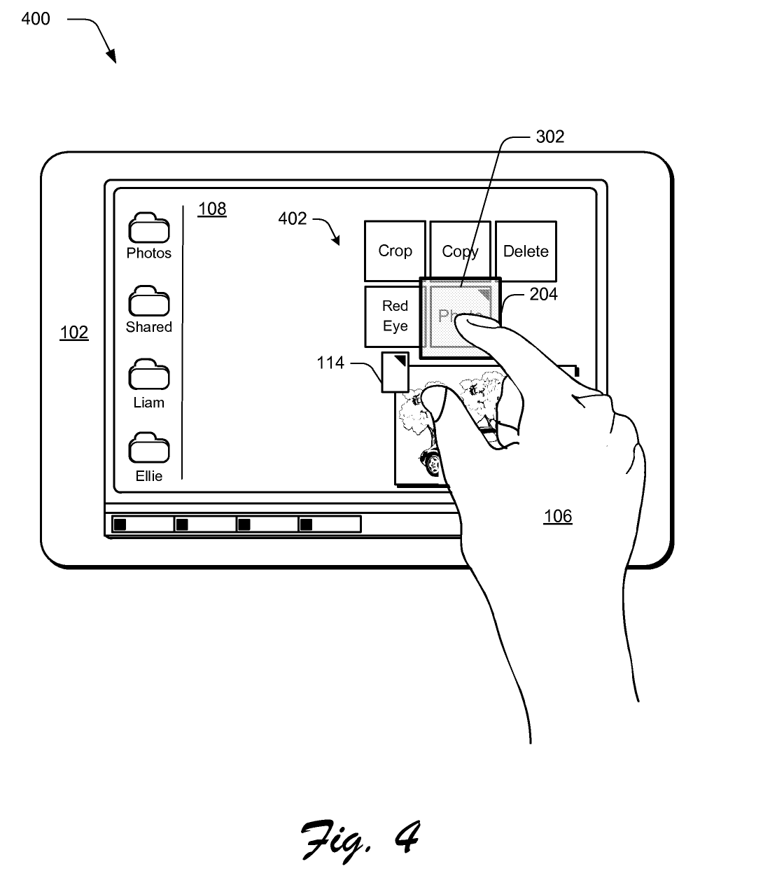

FIG. 4 depicts an example implementation 400 in which a result of selection of an item in a previous hierarchical level 202 in a menu is shown as causing output of another hierarchical level 402 in the menu. In this example, the photo 302 item is selected through surrounding of the item using the visual indication 204 for a predefined amount of time.

In response, the menu module 112 causes a sub-menu of items from another hierarchical level 402 in the menu to be output that related to the photo 302 item. The illustrated examples include “crop,” “copy,” “delete,” and “red eye.” In this instance, however, the items are representative of commands to be initiated and are not representative of additional hierarchical levels in the men, which is indicated through lack of a triangle in the upper-right corner of the items in this example. Therefore, a user may continue the drag gesture toward a desired one of the items to initiate a corresponding operation. A user may then “lift” the touch input to cause the represented operation to be initiated, may continue selection of the item for a predetermined amount of time, and so on to make the selection.

In the illustrated example, the previous item or items that were used to navigate to a current level in the menu remain displayed. Therefore, a user may select these other items to navigate back through the hierarchy to navigate through different branches of the menu. For example, the touch input may be dragged to the menu header icon 114 to return to the hierarchical level 202 of the menu shown in FIG. 2.

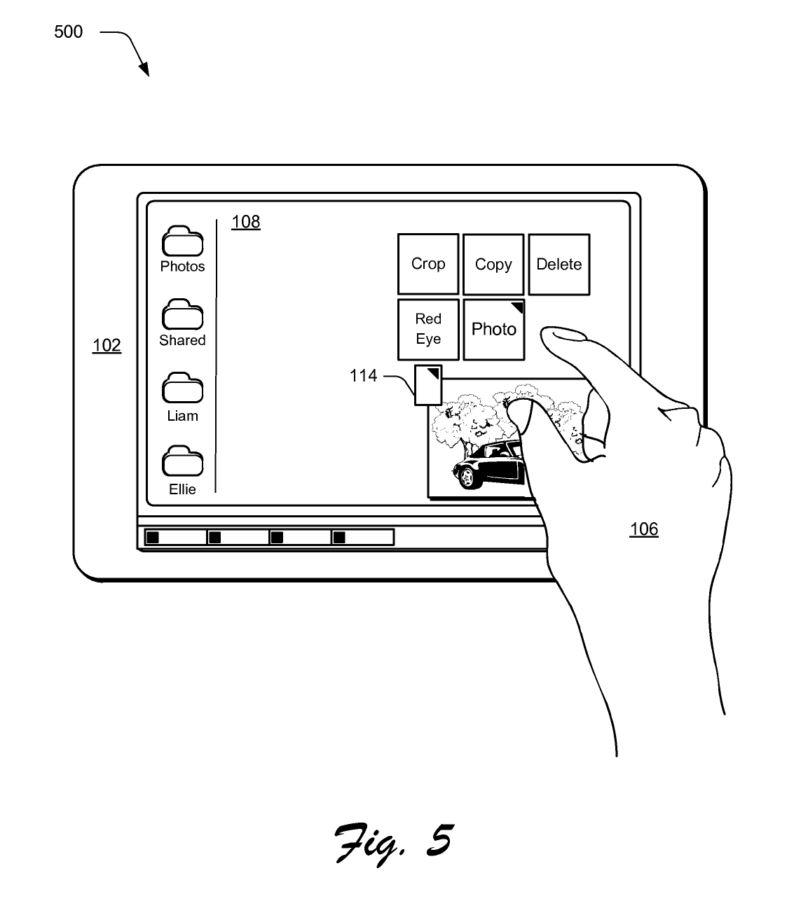

If the user desires to exit from navigating through the menu, the touch input may be dragged outside of a boundary of the items in the menu. Availability of this exit without selecting an item may be indicated by removing the visual indication 204 from display when outside of this boundary, an example of which in shown in FIG. 5. In this way, a user may be readily informed that an item will not be selected and it is “safe” to remove the touch input without causing an operation of the computing device 102 to be initiated.

Although indications of availability of drag gestures were described above, the menu module 112 may also support tap gestures. For example, the menu module 112 may be configured to output the menu and/or different levels of the menu for a predefined amount of time. Therefore, even if a touch input is removed (e.g., the finger of the user's hand is removed from the display device 108), a user may still view items and make a selection by tapping on an item in the menu to be selected.

Additionally, this amount of time may be defined to last longer in response to recognition of a tap gesture. Thus, the menu module 112 may identify a type of usage with which a user is familiar (e.g., cursor control versus touchscreen) and configure interaction accordingly, such as to set the amount of time the menu is to be displayed without receiving a selection. In another example, an amount of time may be varied when tapping a header, e.g., depending on a number of items that are sub-items to that header. Further discussion of these and other techniques may be found in relation to the following procedures.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the computing device 102 may also include an entity (e.g., software) that causes hardware of the computing device 102 to perform operations, e.g., processors, functional blocks, and so on. For example, the computing device 102 may include a computer-readable medium that may be configured to maintain instructions that cause the computing device, and more particularly hardware of the computing device 102 to perform operations. Thus, the instructions function to configure the hardware to perform the operations and in this way result in transformation of the hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

### Example Procedures

The following discussion describes menu gesture techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the example implementations 200-500 of FIGS. 2-5, respectively.

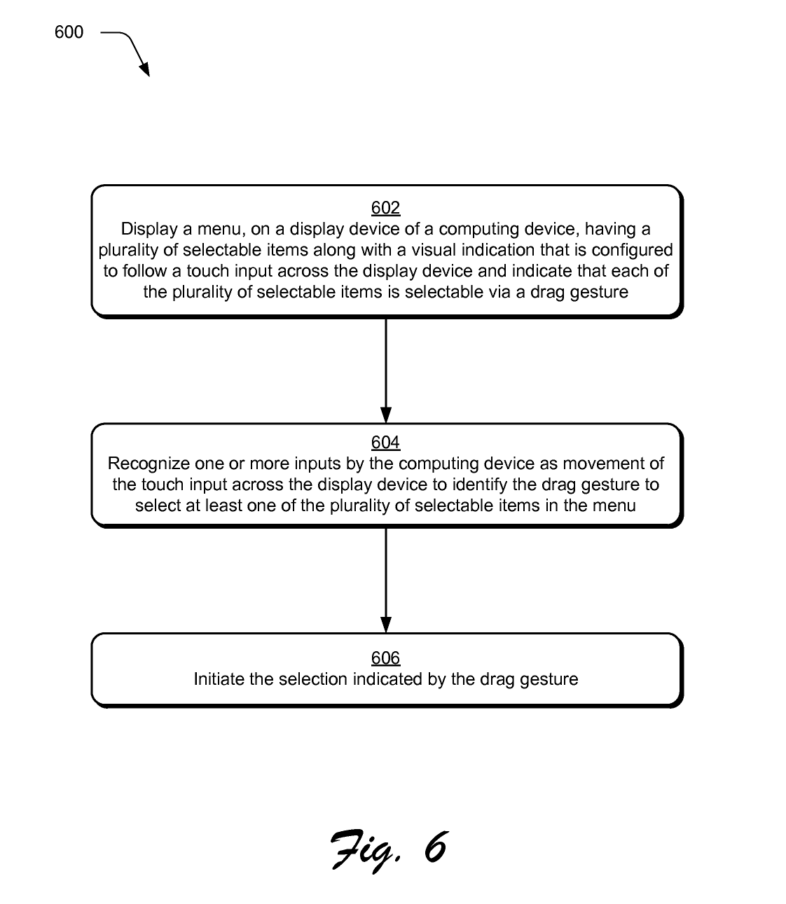

FIG. 6 depicts a procedure 600 in an example implementation in which a menu is configured to indicate support for drag gestures using a visual indication. A menu is displayed on a display device of a computing device, the menu having a plurality of selectable items along with a visual indication that is configured to follow a touch input across the display device and indicate that each of the plurality of selectable items is selectable via a drag gesture (block 602). As shown in FIGS. 2-4, for instance, a level of a menu may be output. The menu may be configured as a hierarchy of items that are selectable to either navigate through the menu or cause performance of a represented operation.

One or more inputs are recognized by the computing device as movement of the touch input across the display device to identify the drag gesture to select at least one of the plurality of selectable items in the menu (block 604). The selection indicated by the drag gesture is initiated (block 606). Continuing with the previous example, the initiation of the touch input in FIG. 1, movement in FIG. 2, and subsequent selection and release in FIG. 3 may be recognized by the menu module 112 as a drag gesture. This drag gesture may then be used to initiate an operation of the computing device 102, such as to select the item at which the “lift off” of the touch input was recognized. A variety of other drag gestures are also contemplated.

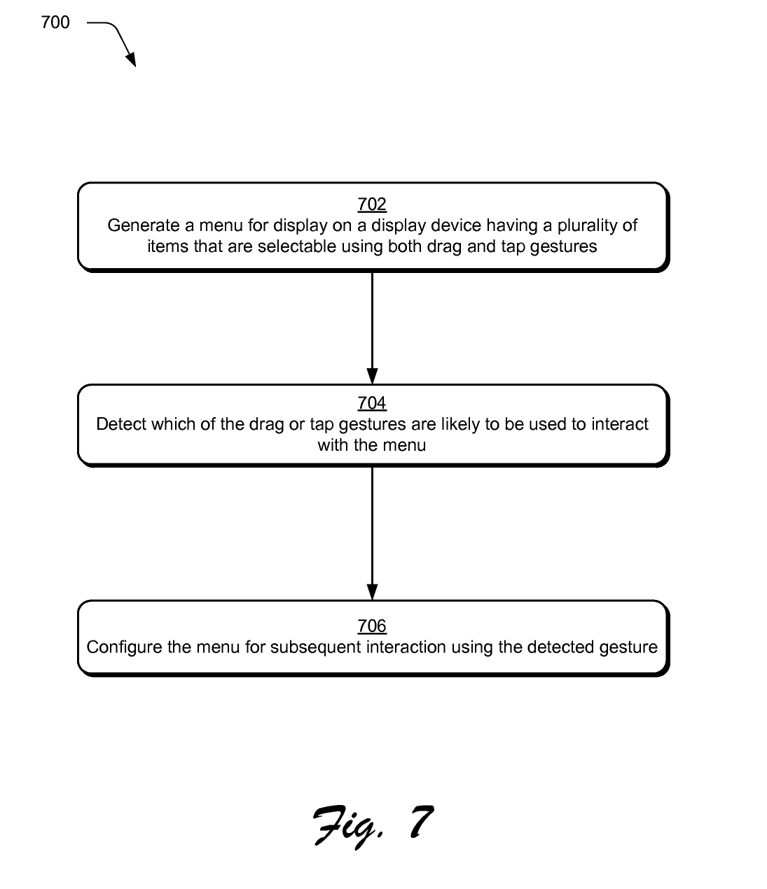

FIG. 7 depicts a procedure 700 in an example implementation in which a menu is generated for display and configured accordingly to detected interaction with the menu. A menu is generated for display on a display device having a plurality of items that are selectable using both drag and tap gestures (block 702). As described in relation to FIGS. 2-5, for instance, items in a menu may be navigated and selected through use of a drag gesture in which involves a touch input involving contact, movement, and subsequent release of the contact. The items may also be selected using one or more “tap gestures” to select items to navigate and/or initiate an operation.

A menu module 112 detects which of the drag or tap gestures are likely to be used to interact with the menu (block 704). The menu may then be configured for subsequent interaction using the detected gesture (block 706). The menu module 112, for instance, may detect that a user has selected the menu header icon 114 using a tap gesture and may therefore determine that the user is likely to continue interaction with the menu using taps. Therefore, the menu module 114 may configure the menu for subsequent tap gestures. For example, the menu module 114 may cause levels of the menu to be displayed for a longer period of time upon removal of the touch input to give a user time to view and make selections of items than would otherwise be the case for a drag gesture. A variety of other examples are also contemplated without departing from the spirit and scope thereof.

### Example System and Device

FIG. 8 illustrates an example system 800 that includes the computing device 102 as described with reference to FIG. 1. The example system 800 enables ubiquitous environments for a seamless user experience when running applications on a personal computer (PC), a television device (e.g., multiuser device such as a computer assuming a form factor of a table that is accessible by multiple users), and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 802, mobile 804, and television 806 uses. Each of these configurations includes devices that may have generally different constructs and capabilities, and thus the computing device 102 may be configured according to one or more of the different device classes. For instance, the computing device 102 may be implemented as the computer 802 class of a device that includes a personal computer, desktop computer, a multi-screen computer, laptop computer, netbook, and so on.

The computing device 102 may also be implemented as the mobile 804 class of device that includes mobile devices, such as a mobile phone, portable music player, portable gaming device, a tablet computer, a multi-screen computer, and so on. The computing device 102 may also be implemented as the television 806 class of device that includes devices having or connected to generally larger screens in casual viewing environments. These devices include televisions, set-top boxes, gaming consoles, and so on. For example, the computing device may have a form factor of a table. The table form factor includes a housing having a plurality of legs. The housing also includes a table top having a surface that is configured to display one or more images, e.g., operate as a display device 108. It should be readily apparent that a wide variety of other data may also be displayed, such as documents and so forth.

The gesture techniques described herein may be supported by these various configurations of the computing device 102 and are not limited to the specific examples the techniques described herein. This is illustrated through inclusion of the gesture module 104 on the computing device 102.

The cloud 808 includes and/or is representative of a platform 810 for content services 812. The platform 810 abstracts underlying functionality of hardware (e.g., servers) and software resources of the cloud 808. The content services 812 may include applications and/or data that can be utilized while computer processing is executed on servers that are remote from the computing device 102. Content services 812 can be provided as a service over the Internet and/or through a subscriber network, such as a cellular or Wi-Fi network.

The platform 810 may abstract resources and functions to connect the computing device 102 with other computing devices. The platform 810 may also serve to abstract scaling of resources to provide a corresponding level of scale to encountered demand for the content services 812 that are implemented via the platform 810. Accordingly, in an interconnected device embodiment, implementation of functionality of the functionality described herein may be distributed throughout the system 800. For example, the functionality may be implemented in part on the computing device 102 as well as via the platform 810 that abstracts the functionality of the cloud 808.

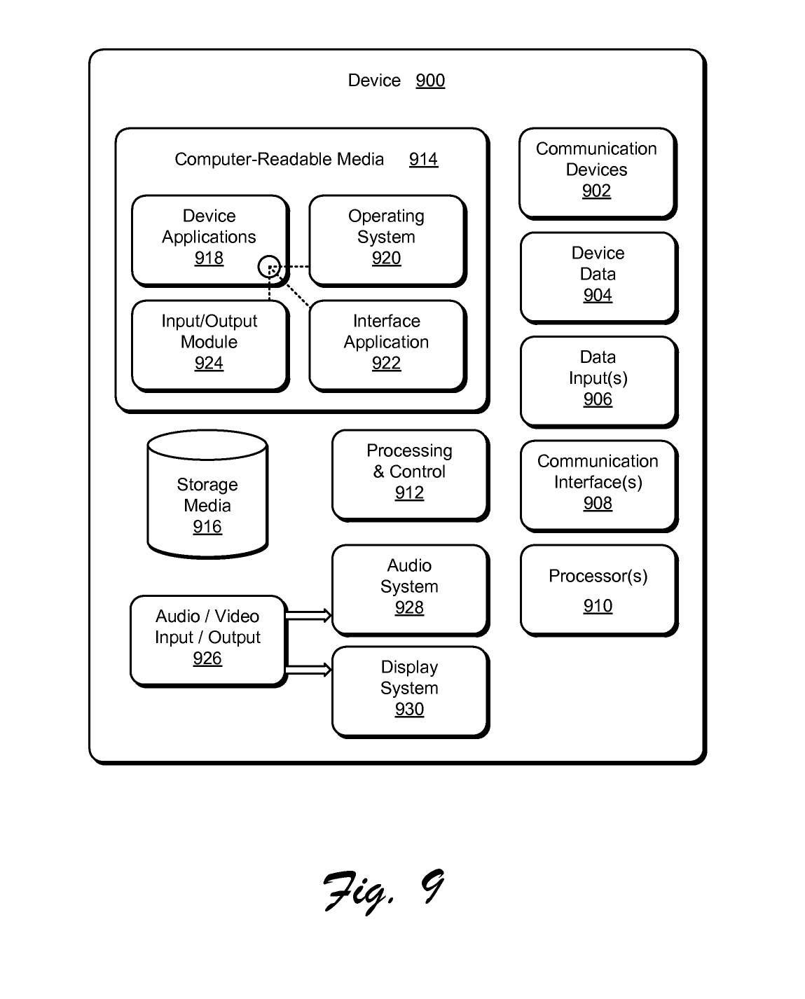

FIG. 9 illustrates various components of an example device 900 that can be implemented as any type of computing device as described with reference to FIGS. 1, 2, and 8 to implement embodiments of the techniques described herein. Device 900 includes communication devices 902 that enable wired and/or wireless communication of device data 904 (e.g., received data, data that is being received, data scheduled for broadcast, data packets of the data, etc.). The device data 904 or other device content can include configuration settings of the device, media content stored on the device, and/or information associated with a user of the device. Media content stored on device 900 can include any type of audio, video, and/or image data. Device 900 includes one or more data inputs 906 via which any type of data, media content, and/or inputs can be received, such as user-selectable inputs, messages, music, television media content, recorded video content, and any other type of audio, video, and/or image data received from any content and/or data source.

Device 900 also includes communication interfaces 908 that can be implemented as any one or more of a serial and/or parallel interface, a wireless interface, any type of network interface, a modem, and as any other type of communication interface. The communication interfaces 908 provide a connection and/or communication links between device 900 and a communication network by which other electronic, computing, and communication devices communicate data with device 900.

Device 900 includes one or more processors 910 (e.g., any of microprocessors, controllers, and the like) which process various computer-executable instructions to control the operation of device 900 and to implement embodiments of the techniques described herein. Alternatively or in addition, device 900 can be implemented with any one or combination of hardware, firmware, or fixed logic circuitry that is implemented in connection with processing and control circuits which are generally identified at 912. Although not shown, device 900 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 900 also includes computer-readable media 914, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 900 can also include a mass storage media device 916.

Computer-readable media 914 provides data storage mechanisms to store the device data 904, as well as various device applications 918 and any other types of information and/or data related to operational aspects of device 900. For example, an operating system 920 can be maintained as a computer application with the computer-readable media 914 and executed on processors 910. The device applications 918 can include a device manager (e.g., a control application, software application, signal processing and control module, code that is native to a particular device, a hardware abstraction layer for a particular device, etc.). The device applications 918 also include any system components or modules to implement embodiments of the techniques described herein. In this example, the device applications 918 include an interface application 922 and an input/output module 924 (which may be the same or different as input/output module 114) that are shown as software modules and/or computer applications. The input/output module 924 is representative of software that is used to provide an interface with a device configured to capture inputs, such as a touchscreen, track pad, camera, microphone, and so on. Alternatively or in addition, the interface application 922 and the input/output module 924 can be implemented as hardware, software, firmware, or any combination thereof. Additionally, the input/output module 924 may be configured to support multiple input devices, such as separate devices to capture visual and audio inputs, respectively.

Device 900 also includes an audio and/or video input-output system 926 that provides audio data to an audio system 928 and/or provides video data to a display system 930. The audio system 928 and/or the display system 930 can include any devices that process, display, and/or otherwise render audio, video, and image data. Video signals and audio signals can be communicated from device 900 to an audio device and/or to a display device via an RF (radio frequency) link, S-video link, composite video link, component video link, DVI (digital video interface), analog audio connection, or other similar communication link. In an embodiment, the audio system 928 and/or the display system 930 are implemented as external components to device 900. Alternatively, the audio system 928 and/or the display system 930 are implemented as integrated components of example device 900.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
displaying a menu, on a display device of a computing device, having a plurality of selectable items along with a visual indication that is configured to follow a touch input across the display device and indicate that each of the plurality of selectable items is selectable via a drag gesture; and
recognizing one or more inputs by the computing device as movement of the touch input across the display device to identify the drag gesture to select at least one of the plurality of selectable items in the menu.

2. A method as described in claim 1, wherein at least one of the selectable items is selectable to navigate to another level in a hierarchy of the menu.

3. A method as described in claim 1, wherein the visual is displayed as at least partially transparent.

4. A method as described in claim 1, wherein the visual indication is configured to be removed in response to a recognition in the one or more inputs that the touch input has moved across the display device and outside of a predefined area of the menu on the display device.

5. A method as described in claim 4, wherein the removal of the visual indication indicates that none of the plurality of items in the menu is currently selected using the touch input.

6. A method as described in claim 1, wherein each of the plurality of selectable items is also configured for selection using a tap gesture.

7. A method as described in claim 1, wherein the displaying is configured to be performed for a predetermined amount of time after the touch input is removed from the display device.

8. A method as described in claim 1, further comprising responsive to the selection of the at least one of the plurality of selectable items in the menu, displaying another plurality of selectable items from another hierarchical level of the menu that corresponds to the selected item.

9. A method as described in claim 8, wherein the display of the other plurality of selectable items is performed such that the other plurality of selectable items are not obscured by the touch input against the display device.

10. An apparatus comprising:
a display device; and
one or more modules implemented at least partially in hardware, the one or more modules configured to generate a menu for display on the display device, the menu having a plurality of items that are selectable using both drag and tap gestures.

11. An apparatus as described in claim 10, wherein the one or more modules are further configured to generate a visual indication that is configured to follow a touch input across the display device.

12. An apparatus as described in claim 11, wherein the visual indication is configured to be removed in response to recognition that the touch input has moved across the display device and outside of a predefined area of the menu on the display device.

13. An apparatus as described in claim 10, wherein the one or more modules are further configured to recognize the drag gesture as movement of a touch input across the display device to select at least one of the plurality of items in the menu.

14. An apparatus as described in claim 10, wherein the display is configured to be performed for a predetermined amount of time after a touch input is removed from the display device.

15. An apparatus as described in claim 10, wherein the one or more modules are further configured to recognize selection of at least one of the plurality of items in the menu and display a second plurality of items on the display device from another hierarchical level of the menu that corresponds to the selected item.

16. An apparatus as described in claim 15, wherein the display of the other plurality of selectable items is performed such that:
the second plurality of items are not obscured by the touch input against the display device;
the at least one of the plurality of items that was selected is displayed with the second plurality of items; and
one or more other ones of the plurality of items that is not selected is not displayed with the second plurality of items.

17. An apparatus as described in claim 16, wherein the at least one of the plurality of items that was selected and displayed with the other plurality of selectable items is selectable to return to a display of the plurality of items.

18. An apparatus as described in claim 17, wherein the return to the display of the plurality of items causes the second plurality of items to be removed from display.

19. One or more computer-readable storage media comprising instructions stored thereon that, responsive to execution by a computing device, causes the computing device to generate a menu for display on a display device of the computing device along with a visual indication that is configured to follow a touch input across the display device and indicate that each of a plurality of items of the menu is selectable via a drag gesture, the plurality of items also selectable via a tap gesture.

20. One or more computer-readable storage media as described in claim 19, wherein the instructions are further executable to arrange the plurality of items so as not to be obscured by the touch input.
